(19) United States
(12) Patent Application Publication
(10) Pub. No.: US 2026/0161420 A1
(43) Pub. Date: Jun. 11, 2026

(54) MOBILE DEVICE PREPARATION SYSTEM

(71) Applicant: TOSHIBA GLOBAL COMMERCE SOLUTIONS, INC., Durham, NC (US)

(72) Inventors: Manda MILLER, Raleigh, NC (US); Ashley WEHR, Minneapolis, MN (US); Akshay Kumar PANDIT, Morrisville, NC (US); Kristen M. CHUNG, Cornelius, NC (US); Albert D. BENNAH, Cary, NC (US)

(21) Appl. No.: 18/971,710

(22) Filed: Dec. 6, 2024

(51) Int. Cl. G06F 9/4401; G06Q 10/04

(52) U.S. Cl. CPC G06F 9/4401; G06Q 10/04

(57) ABSTRACT

The present disclosure describes a computer system that automatically prepares mobile devices. The computer system includes a memory and a processor. The processor determines, based on an image of a checkout area, at least one of a wait time or a number of people at the checkout area, loads, based on at least one of the wait time or the number of people exceeding a threshold, a first application on a mobile device, and instructs that the mobile device use the first application at the checkout area.

### BACKGROUND

The present disclosure relates to the automatic preparation of mobile devices. Mobile devices are used in commercial environments (e.g., retail stores, warehouses, etc.) to perform different tasks. For example, the mobile devices may be used to for line busting, pop-up stores, click-n-collect, inventory management, etc. A mobile device may be loaded with different applications to perform these tasks. When a user is assigned one of these tasks, the user may boot up a mobile device and load the appropriate application for the task. The user then uses the mobile device to perform the task. The process of manually booting the mobile device and loading the application, however, may be burdensome and take time that the user could be using to perform the task.

### BRIEF DESCRIPTION OF THE DRAWINGS

FIG. 1 illustrates an example system.

FIG. 2 illustrates an example operation performed by the system of FIG. 1.

FIG. 3 illustrates an example operation performed by the system of FIG. 1.

FIG. 4 illustrates an example operation performed by the system of FIG. 1.

FIG. 5 is a flowchart of an example method performed by the system of FIG. 1.

### DETAILED DESCRIPTION

The present disclosure describes a computer system that automatically prepares mobile devices. The computer system receives inputs from various sensors in a commercial environment. For example, the computer system may receive videos from cameras, temperatures from temperature sensors, signals from location beacons, etc. The computer system analyzes these inputs to determine whether to deploy a mobile device to perform a task. If the computer system determines that a mobile device should be deployed, the computer system selects a mobile device (e.g., from a bank of charging mobile devices) and automatically prepares the mobile device for the task. For example, the computer system may boot the mobile device and/or load an application for the task on the mobile device. When a user takes the mobile device, the user may begin using the mobile device to perform the task without having to boot the mobile device or load the application.

When the computer system detects, from the inputs, that the mobile device should be re-purposed to perform a new task in the commercial environment, the computer system may automatically load another application for performing the new task. The user may then take the mobile device to another location in the commercial environment and perform the new task using the mobile device.

### Technical Advantages

In certain embodiments, the computer system provides several technical advantages. For example, the computer system reduces the amount of time spent waiting for a device to boot and to load an application before using the device to perform a task. As another example, the computer system improves the functioning of the device by ensuring that the device loads the correct application for performing a particular task.

### Example Embodiments

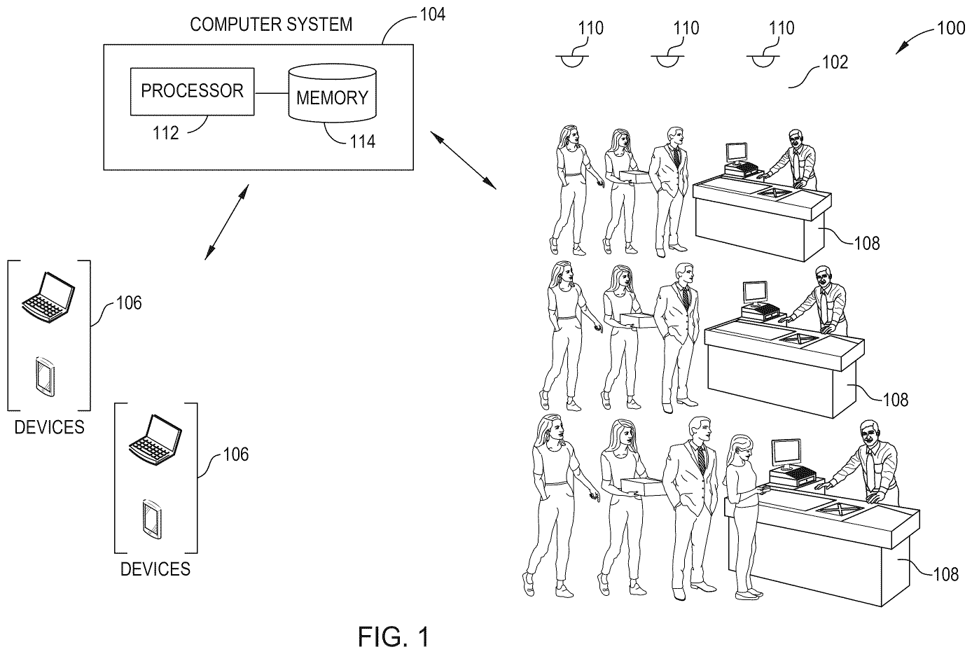

FIG. 1 illustrates an example system 100, which may be a retail store. As seen in FIG. 1, the system 100 includes a checkout area 102, a computer system 104, and one or more mobile device 106. Generally, the computer system 104 detects when a mobile device 106 should be deployed to perform a task, and the computer system 104 automatically prepares the mobile device 106 to perform the task.

The system 100 may include several different areas. For clarity, the checkout area 102 is illustrated, but it is understood that the system 100 may include other areas, such as a storage area for inventory or a pick-up area where items may be collected or retrieved. As seen in FIG. 1, the checkout area 102 includes one or more checkout stations 108 where items may be purchased.

The mobile devices 106 may be used in the different areas to perform different tasks. For example, a mobile device 106 may be used in the checkout area 102 for line busting (e.g., the mobile device 106 may help scan items and conduct purchases when there are long lines at the checkout stations 108). As another example, a mobile device 106 may be used in the storage area to count or process inventory. The mobile device 106 may have different applications installed on the mobile device 106 to perform the different tasks.

The checkout area 102 includes multiple sensors 110 that capture information about the checkout area 102. For example, the sensors 110 may include cameras that capture images or videos of the checkout area 102. These images or videos may reveal whether there are long lines forming at the checkout area 102. As another example, the sensors 110 may include temperature sensors positioned within the checkout stations 108. The temperature sensors may detect the temperature of the electronic equipment at the checkout stations 108. The temperature may reveal whether the equipment is overheating or stressed. As another example, the sensors 110 may include location beacons that detect where people and/or devices are in the commercial environment. The sensors 110 may provide, to the computer system 104, signals that indicate the information captured or sensed by the sensors 110.

The computer system 104 uses the information from the sensors 110 to automatically detect when a mobile device 106 should be deployed in the system 100 to perform a task. The computer system 104 then automatically prepares the mobile device 106 to perform the task. For example, the computer system 104 may boot the mobile device 106 and load the appropriate application on the mobile device 106. As seen in FIG. 1, the computer system 104 includes a processor 112 and a memory 114, which perform the functions or actions of the computer system 104 described herein.

The processor 112 is any electronic circuitry, including, but not limited to one or a combination of microprocessors, microcontrollers, application specific integrated circuits (ASIC), application specific instruction set processor (ASIP), and/or state machines, that communicatively couples to the memory 114 and controls the operation of the computer system 104. The processor 112 may be 8-bit, 16-bit, 32-bit, 64-bit or of any other suitable architecture. The processor 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 112 may include other hardware that operates software to control and process information. The processor 112 executes software stored on the memory 114 to perform any of the functions described herein. The processor 112 controls the operation and administration of the computer system 104 by processing information (e.g., information received from the mobile devices 106, the sensors 110, and the memory 114). The processor 112 is not limited to a single processing device and may encompass multiple processing devices contained in the same device or computer or distributed across multiple devices or computers. The processor 112 is considered to perform a set of functions or actions if the multiple processing devices collectively perform the set of functions or actions, even if different processing devices perform different functions or actions in the set.

The memory 114 may store, either permanently or temporarily, data, operational software, or other information for the processor 112. The memory 114 may include any one or a combination of volatile or non-volatile local or remote devices suitable for storing information. For example, the memory 114 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 114, a disk, a CD, or a flash drive. In particular embodiments, the software may include an application executable by the processor 112 to perform one or more of the functions described herein. The memory 114 is not limited to a single memory and may encompass multiple memories contained in the same device or computer or distributed across multiple devices or computers. The memory 114 is considered to store a set of data, operational software, or information if the multiple memories collectively store the set of data, operational software, or information, even if different memories store different portions of the data, operational software, or information in the set.

The mobile device 106 is any suitable device for communicating with components of the system 100. As an example and not by way of limitation, the mobile device 106 may be a computer, a laptop, a wireless or cellular telephone, an electronic notebook, a personal digital assistant, a tablet, or any other device capable of receiving, processing, storing, or communicating information with other components of the system 100. The mobile device 106 may be a wearable device such as a virtual reality or augmented reality headset, a smart watch, or smart glasses. The mobile device 106 may also include a user interface, such as a display, a microphone, keypad, or other appropriate terminal equipment usable by the user. The mobile device 106 may include a hardware processor, memory, or circuitry configured to perform any of the functions or actions of the mobile device 106 described herein. For example, a software application designed using software code may be stored in the memory and executed by the processor to perform the functions of the mobile device 106.

As an example operation, the computer system 104 may receive inputs from the sensors 110. For example, the computer system 104 may receive images or videos captured by cameras in the checkout area 102. The computer system 104 may analyze the images or videos using computer vision techniques to determine a number of people waiting at the checkout area 102 or a wait time for the people at the checkout area 102. If the number of people or the wait time exceeds a threshold, the computer system 104 may determine that a mobile device 106 should be deployed to the checkout area 102 to perform line busting.

The computer system 104 may communicate a signal to the mobile device 106 to instruct the mobile device 106 to prepare for line busting. For example, the instruction may boot the mobile device 106 and load an installed line busting application on the mobile device 106. A user may carry the mobile device 106 to the checkout area 102 and use the mobile device 106 to perform line busting. As seen in this example, the user did not manually boot the mobile device 106 or manually load the application on the mobile device 106. Instead, the computer system 104 automatically performed these operations on the mobile device 106 to prepare the mobile device 106 for line busting. As a result, the mobile device 106 may be deployed and used faster than in existing implementations in which the user manually boots the mobile device 106 and manually loads the application.

The computer system 104 may receive images or videos from the camera that show the lines at the checkout area 102 getting shorter. The computer system 104 uses computer vision techniques to analyze the images or videos to determine an updated wait time or an updated number of people at the checkout area 102. When the wait time or the number of people fall below the threshold, the computer system 104 may determine that the mobile device 106 should be re-purposed. For example, the computer system 104 may determine that the mobile device 106 should be deployed in a storage area to process inventory. The computer system 104 may communicate a signal to the mobile device 106 to instruct the mobile device 106 to load an application for processing inventory. The user may carry the mobile device 106 to the storage area and begin processing inventory using the loaded application. In this manner, the computer system 104 automatically prepares re-purposes the mobile device 106 depending on the needs in the commercial environment.

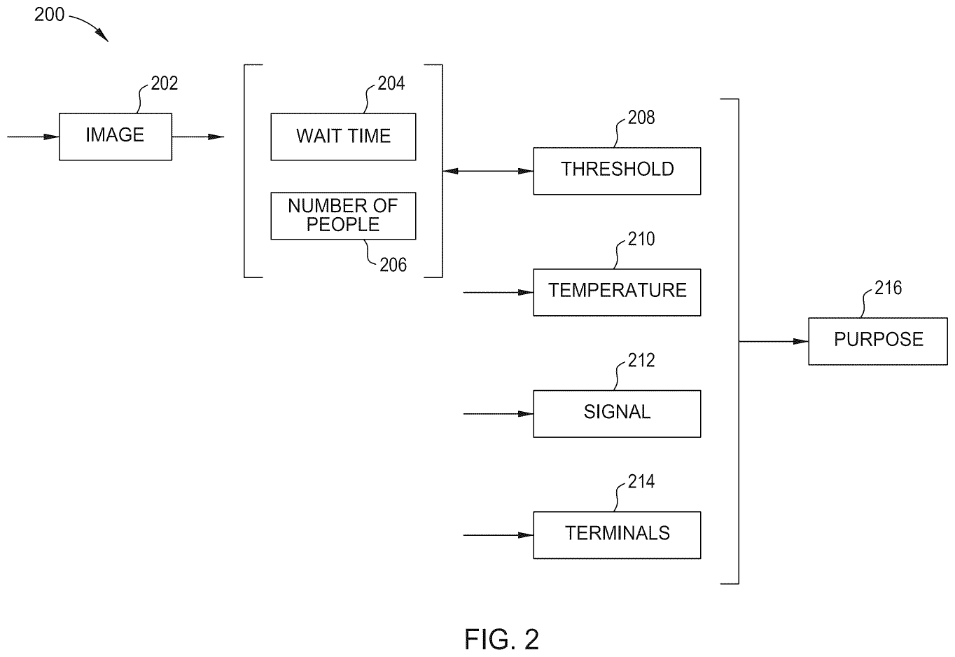

FIG. 2 illustrates an example operation 200 performed by the system 100 of FIG. 1. A computer system (e.g., the computer system 104 shown in FIG. 1) may perform the operation 200. By performing the operation 200, the computer system determines whether a mobile device (e.g., the mobile device 106 shown in FIG. 1) should be deployed.

The computer system begins by receiving an image 202. The image 202 may be a photograph captured by a camera or a frame of a video captured by the camera. The image 202 may show a portion of a space. For example, the image 202 may show a checkout area of a retail store. The image 202 may also show people waiting at the checkout area.

The computer system uses computer vision techniques to analyze the image 202. For example, the computer system may use computer vision techniques to determine a wait time 204 for the people in the image 202 or a number 206 of people waiting in the image 202. The computer system then compares the wait time 204 or the number 206 of people to a threshold 208 to determine whether remedial measures should be taken to alleviate the wait time 204 or to reduce the number 206 of people waiting. For example, if the wait time 204 or the number 206 of people exceeds the threshold 208, then the computer system may determine that a mobile device should be deployed to the checkout area to perform line busting. If the wait time 204 or the number 206 of people do not exceed the threshold 208, then the computer system may refrain from deploying the mobile device to the checkout area.

The computer system may consider other information when determining whether to deploy the mobile device. For example, the computer system may receive a temperature 210 detected by a temperature sensor. The temperature sensor may be deployed in electronic equipment in the checkout area. Based on the temperature 210, the computer system may determine whether the electronic hardware is stressed or overloaded/overheating. If so, the computer system may determine that the mobile device should be deployed to perform line busting that would relieve the load on the electronic equipment.

As another example, the computer system may receive a signal 212 from a location beacon. The location beacon may be part of an ultra wideband system used to track inventory in the space. For example, the signal 212 may indicate that a large amount of inventory is waiting to be processed in a storage area. The computer system may determine, based on the signal 212, that the mobile device should be deployed to the storage area to process inventory.

As another example, the computer system may receive or determine a number of terminals 214 (e.g., checkout terminals) that are functioning or available at the checkout area. For example, the terminals 214 may report to the computer system whether the terminals 214 are in operation. Using this information, the computer system may determine whether the mobile device should be deployed to the checkout area to perform line busting. For example, if a small number of terminals are available or functioning, then the computer system may determine that extra assistance is needed at the checkout area and deploy the mobile device to the checkout area.

The computer system determines a purpose 216 for the mobile device using the wait time 204, the number 206 of people, the threshold 208, the temperature 210, the signal 212, and/or the terminals 214. For example, the purpose 216 may be to perform line busting at the checkout area. As another example, the purpose 216 may be to process inventory in the storage area. After determining the purpose 216, the computer system may automatically prepare the mobile device to fulfill the purpose 216.

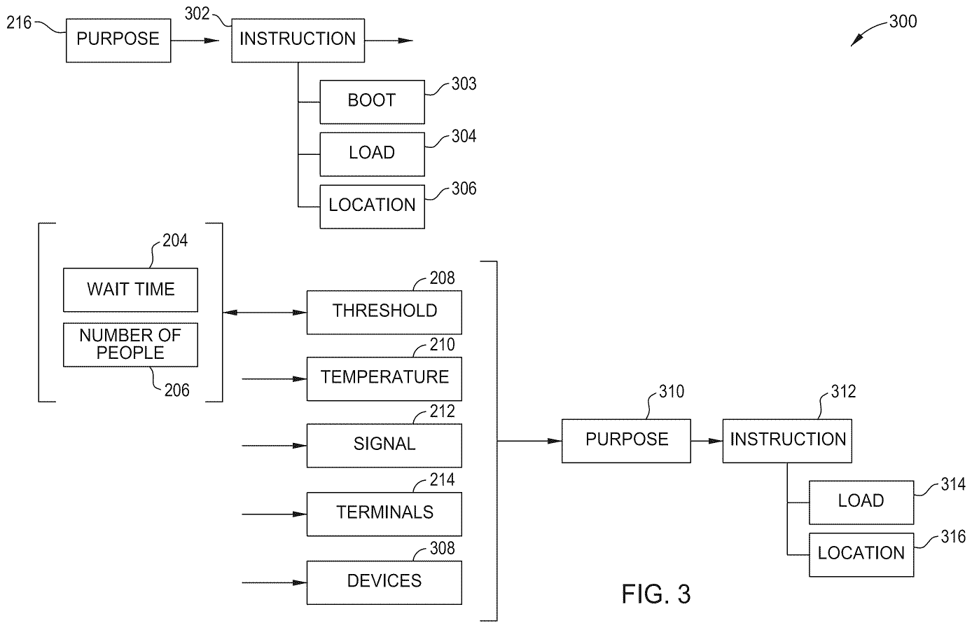

FIG. 3 illustrates an example operation 300 performed by the system 100 of FIG. 1. A computer system (e.g., the computer system 104 shown in FIG. 1) performs the operation 300. By performing the operation 300, the computer system automatically prepares a mobile device (e.g., the mobile device 106 shown in FIG. 1).

The computer system begins with the determined purpose 216 for the mobile device. The computer system generates an instruction 302 for fulfilling the purpose 216. The instruction 302 may include portions that instruct the mobile device what functions to perform. For example, the instruction 302 may include a boot portion 303, a load portion 304, and/or a location portion 306. The boot portion 303 may instruct the mobile device to boot, which may turn on or activate the mobile device. The load portion 304 may instruct the mobile device to load a particular, installed application. This application may be used to fulfill the purpose 216. The location portion 306 may instruct the mobile device where to deploy. The computer system may communicate the instruction 302 to the mobile device.

When the mobile device receives the instruction 302, the mobile device may boot according to the boot portion 303, if present in the instruction 302. The mobile device may also load an application according to the load portion 304. The mobile device may further display a message indicating the location where the mobile device should be deployed according to the location portion 306. A user may see the displayed message and take the mobile device the location to perform tasks using the loaded application. In this manner, the user avoids having to manually boot the mobile device and to manually load the application, which reduces the amount of time it takes before the user can use the mobile device to perform tasks relative to existing systems.

The computer system may re-purpose the mobile device as conditions in the space changes. For example, if the mobile device was deployed to perform line busting, then the mobile device may reduce the wait time in the checkout area or the number of people waiting in the checkout area. As the conditions change, the computer system may determine that it would be more useful or helpful for the mobile device to be deployed to another area to perform a different task (e.g., due to an emerging need in that area). The computer system may then instruct the mobile device as to the new area and the new task, which may load another application on the mobile device to perform the new task. The user may then take the mobile device to the new area to perform the new task without manually loading the application.

In the example of FIG. 3, the computer system determines that the wait time 204 and/or the number 206 of people has changed (e.g., reduced due to the mobile device being used for line busting in a checkout area). The computer system may determine that the wait time 204 and/or the number 206 of people has fallen below the threshold 208. The computer system may also determine, from the temperature 210 and/or the number of terminals 214, that the checkout area can sufficiently handle the people who are still waiting at the checkout area. In response, the computer system may look to re-purpose the mobile device.

For example, the computer system may analyze the signal 212 from the location beacon and determine that a large amount of inventory is awaiting processing in the storage area. In response, the computer system may determine a purpose 310 for the mobile device. The purpose 310 may indicate that the mobile device should be moved to the storage area to process inventor. The computer system may generate an instruction 312 for the purpose 310. The instruction 312 may include a load portion 314 and a location portion 316. In this example, the load portion 314 may indicate that an application for processing inventor should be loaded, and the location portion 316 may indicate the storage area.

The computer system may communicate the instruction 312 to the mobile device. In response, the mobile device may load the application for processing inventory. Additionally, the mobile device may display a message indicating that the mobile device should be moved to the storage area to process inventory. When a user sees the message, the user may bring the mobile device to the storage area and use the mobile device to process inventory. Because the mobile device automatically loaded the application to process inventory, the user need not load the application manually.

In some embodiments, the computer system may receive and consider a number of mobile devices 308 that are available when determining whether to re-purpose the mobile device. For example, if many mobile devices 308 are available for use, then the computer system may deploy one of those mobile devices 308 rather than re-purposing the mobile device. In this manner, the computer system gives the mobile device an opportunity recharge before being deployed to another area to perform tasks.

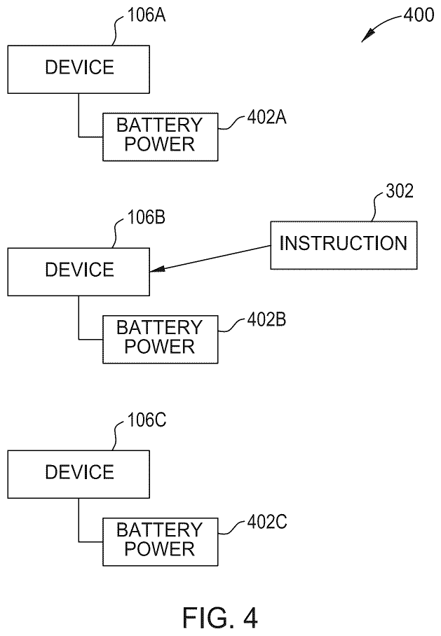

FIG. 4 illustrates an example operation 400 performed by the system 100 of FIG. 1. A computer system (e.g., the computer system 104 shown in FIG. 1) performs the operation 300. By performing the operation 300, the computer system selects a mobile device (e.g., the mobile device 106 shown in FIG. 1) for deployment.

The computer system may select a mobile device from a bank of mobile devices (e.g., a group of mobile devices charging at a charging station) using any criteria. As seen in FIG. 4, the computer system selects from a mobile device 106A, a mobile device 106B, and a mobile device 106C. When the computer system determines that a mobile device 106 should be deployed, the computer system may select the mobile device 106 based on the amount of batter power 402 remaining in the mobile device 106. In the example of FIG. 4, the mobile device 106A has battery power 402A remaining. The mobile device 106B has battery power 402B remaining. The mobile device 106C has battery power 402C remaining. The computer system may select the mobile device 106B because the battery power 402B is greater than the battery powers 402A and 402C.

The computer system communicates the instruction 302 to the mobile device 106B to deploy the mobile device 106B. The instruction 302 may boot up the mobile device 106B, and the instruction 302 may load an installed application on the mobile device 106B. A user may take the mobile device 106B to a designated area to perform tasks using the loaded application. Because the computer system automatically booted up the mobile device 106B and loaded the application on the mobile device 106B, the user does not need to manually boot up the mobile device 106B or load the application on the mobile device 106B.

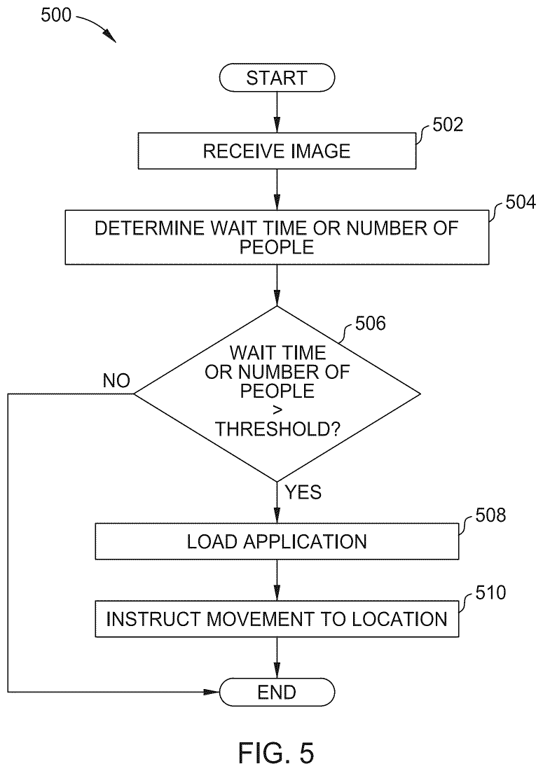

FIG. 5 is a flowchart of an example method 500 performed by the system of FIG. 1. In certain embodiments, a computer system (e.g., the computer system 104 shown in FIG. 1) performs the method 500. By performing the method 500, the computer system automatically prepares a mobile device (e.g., the mobile device 106 shown in FIG. 1) for performing a task.

At 502, the computer system receives an image. The image may be a photograph captured by a camera or a frame of a video captured by the camera. The image may show a checkout area. At 504, the computer system uses computer vision techniques to analyze the image and to determine a wait time at the checkout area or a number of people waiting at the checkout area. The computer system may use this information to determine whether assistance is needed at the checkout area to reduce wait times.

At 506, the computer system determines whether the wait time or the number of people exceed a threshold. If the wait time or the number of people do not exceed the threshold, then the computer system may determine that the mobile device should not be deployed to the checkout area and end the method 500. If the wait time or the number of people exceed the threshold, then the computer system may determine that assistance is needed at the checkout area and that the mobile device should be deployed to the checkout area.

The computer system then begins preparing the mobile device. At 508, the computer system loads an installed application on the mobile device. For example, the computer system may communicate an instruction to the mobile device. When the mobile device receives the instruction, the mobile device loads the application. The application may be used to assist the checkout area (e.g., used for line busting). At 510, the computer system instructs the movement of the mobile device to a location (e.g., the checkout area). The instruction communicated by the computer system may indicate that the mobile device should be deployed at the checkout area. The mobile device may display a message indicating that the mobile device should be moved to the checkout area for line busting. When a user sees the message, the user may take the mobile device to the checkout area and begin using the device to assist the checkout area.

In summary, the computer system 104 automatically prepares mobile devices 106. The computer system 104 receives inputs from various sensors in a commercial environment. For example, the computer system 104 may receive videos from cameras, temperatures from temperature sensors, signals from location beacons, etc. The computer system 104 analyzes these inputs to determine whether to deploy a mobile device 106 to perform a task. If the computer system 104 determines that a mobile device 106 should be deployed, the computer system 104 selects a mobile device 106 (e.g., from a bank of charging mobile devices) and automatically prepares the mobile device 106 for the task. For example, the computer system 104 may boot the mobile device 106 and/or load an application for the task on the mobile device 106. When a user takes the mobile device 106, the user may begin using the mobile device 106 to perform the task without having to boot the mobile device 106 or load the application.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to one or more embodiments, other and further embodiments may be devised without departing from the basic scope thereof, and the scope thereof is determined by the claims that follow.

What is claimed is:

1. A computer system comprising:
one or more memories; and
one or more processors communicatively coupled to the one or more memories, the one or more processors configured to, individually or collectively, perform operations comprising:
determining, based on an image of a checkout area, at least one of a wait time or a number of people at the checkout area;
loading, based on at least one of the wait time or the number of people exceeding a threshold, a first application on a mobile device; and
instructing that the mobile device use the first application at the checkout area.

2. The computer system of claim 1, wherein the operations comprise booting the mobile device based on the wait time or the number of people exceeding a threshold.

3. The computer system of claim 1, wherein determining the wait time or the number of people is further based on at least one of a temperature sensed by a temperature sensor at the checkout area or a signal from a location beacon.

4. The computer system of claim 1, wherein the operations comprise:
determining, based on at least one of an updated wait time or an updated number of people at the checkout area, that the mobile device should be re-purposed;
loading a second application on the mobile device; and
instructing that the mobile device use the second application in another area.

5. The computer system of claim 4, wherein determining that the mobile device should be re-purposed is further based on a number of available mobile devices of a plurality of mobile devices.

6. The computer system of claim 1, wherein the operations comprise selecting the mobile device from a plurality of mobile devices based on an amount of battery power in the mobile device.

7. The computer system of claim 1, wherein loading the first application on the mobile device is further based on a number of functioning terminals at the checkout area.

8. A method comprising:
determining, based on an image of a checkout area, at least one of a wait time or a number of people at the checkout area;
loading, based on at least one of the wait time or the number of people exceeding a threshold, a first application on a mobile device; and
instructing that the mobile device use the first application at the checkout area.

9. The method of claim 8, further comprising booting the mobile device based on the wait time or the number of people exceeding a threshold.

10. The method of claim 8, wherein determining the wait time or the number of people is further based on at least one of a temperature sensed by a temperature sensor at the checkout area or a signal from a location beacon.

11. The method of claim 8, further comprising:
determining, based on at least one of an updated wait time or an updated number of people at the checkout area, that the mobile device should be re-purposed;
loading a second application on the mobile device; and
instructing that the mobile device use the second application in another area.

12. The method of claim 11, wherein determining that the mobile device should be re-purposed is further based on a number of available mobile devices of a plurality of mobile devices.

13. The method of claim 8, further comprising selecting the mobile device from a plurality of mobile devices based on an amount of battery power in the mobile device.

14. The method of claim 8, wherein loading the first application on the mobile device is further based on a number of functioning terminals at the checkout area.

15. A non-transitory computer readable medium storing instructions that, when executed by one or more processors, cause the one or more processors to, individually or collectively, perform operations comprising:
determining, based on an image of a checkout area, at least one of a wait time or a number of people at the checkout area;
loading, based on at least one of the wait time or the number of people exceeding a threshold, a first application on a mobile device; and
instructing that the mobile device use the first application at the checkout area.

16. The medium of claim 15, wherein the operations comprise booting the mobile device based on the wait time or the number of people exceeding a threshold.

17. The medium of claim 15, wherein determining the wait time or the number of people is further based on at least one of a temperature sensed by a temperature sensor at the checkout area or a signal from a location beacon.

18. The medium of claim 15, wherein the operations comprise:
determining, based on at least one of an updated wait time or an updated number of people at the checkout area, that the mobile device should be re-purposed;
loading a second application on the mobile device; and
instructing that the mobile device use the second application in another area.

19. The medium of claim 18, wherein determining that the mobile device should be re-purposed is further based on a number of available mobile devices of a plurality of mobile devices.

20. The medium of claim 15, wherein the operations comprise selecting the mobile device from a plurality of mobile devices based on an amount of battery power in the mobile device.
